(19) United States
(12) Patent Application Publication
(10) Pub. No.: US 2020/0361354 A1
(43) Pub. Date: Nov. 19, 2020

(54) Stowable Swing-Out Table Assembly

(71) Applicant: Cass Hudson, LLC., Elkhart, IN (US)

(72) Inventors: Darren L. Stutesman, Mishawaka, IN (US); David Morgan, Mishwaka, IN (US)

(73) Assignee: Cass Hudson, LLC., Elkhart, IN (US)

(21) Appl. No.: 16/874,986

(22) Filed: May 15, 2020

Related U.S. Application Data
(60) Provisional application No. 62/849,078, filed on May 16, 2019.

(51) Int. Cl. B60N 3/00; A47B 5/04

(52) U.S. Cl. CPC B60N 3/002; A47B 5/04

(57) ABSTRACT

The table assembly provides convenient stowable tables or countertops, which can be rotated and moved i.e., “swung out” of the way to allow ease of user movement around the living space and table. The table assembly includes four main detachable components: a vertical post; a swing arm; a table bracket, which supports a conventional table top; and a mounting part. The Table assembly can be configured as a wall mounted or floor mounted unit, using different embodiments of the mounting part. The table assembly can be locked or secured in any particular position or orientation to hold the table in place and prevent inadvertent movement. In addition, the table assemblies can be disassembled for convenient storage.

This application claims the benefit of U.S. Provisional Application No. 62/849,078 filed May 16, 2019, the disclosure of which is hereby incorporated by reference.

This invention relates to a stowable table used with recreational vehicles, and particularly a stowable table that swings between different useable positions.

### BACKGROUND AND SUMMARY OF THE INVENTION

Stowable tables are common features in recreational vehicles. Typically, a stowable table includes a detachable table top mounted atop removable legs or a single removable pedestal, which are stowed within a compartment or cabinet within the living space of the vehicle. Heretofore, the design of the stowable tables required the user to move and slide along the seating about the fixed table when the table was in its usable position.

The table assembly of this invention is designed for use in recreational vehicles and other applications where living space is limited. The table assembly provides convenient stowable tables or countertops, which can be raised, rotated and moved i.e., “swung out” of the way to allow ease of user movement around the living space and table. The table assembly includes four main detachable components: a vertical post; a swing arm; a table bracket, which supports a conventional table top; and a mounting part. The Table assembly can be configured as a wall mount or floor mounted unit, using different embodiments of the mounting part. The table assembly can be locked or secured in any particular position or orientation to hold the table in place and prevent inadvertent movement. In addition, the table assembly can be disassembled for convenient storage.

The above described features and advantages, as well as others, will become more readily apparent to those of ordinary skill in the art by reference to the following detailed description and accompanying drawings.

### BRIEF DESCRIPTION OF THE DRAWINGS

The present invention may take form in various system and method components and arrangement of system and method components. The drawings are only for purposes of illustrating exemplary embodiments and are not to be construed as limiting the invention. The drawings illustrate the present invention, in which:

FIG. 1 is a perspective view of an exemplary embodiment of the swing-out table of this invention in a wall mount style;

FIG. 2 is an exploded view of the swing-out table of FIG. 1;

FIG. 3 is a side view of the swing-out table of FIG. 1;

FIG. 4 is an exploded view of the wall mount used with the swing-out table of FIG. 1;

FIG. 5 is a perspective view of the wall mount used with the swing-out table of FIG. 1;

FIG. 6 is a top view of the swing-out table of FIG. 1 shown in a first position;

FIG. 7 is a top view of the swing-out table of FIG. 1 shown in a second position; and

FIG. 8 is a perspective view of a second exemplary embodiment of the swing-out table of this invention in a floor mount style.

### DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical, structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

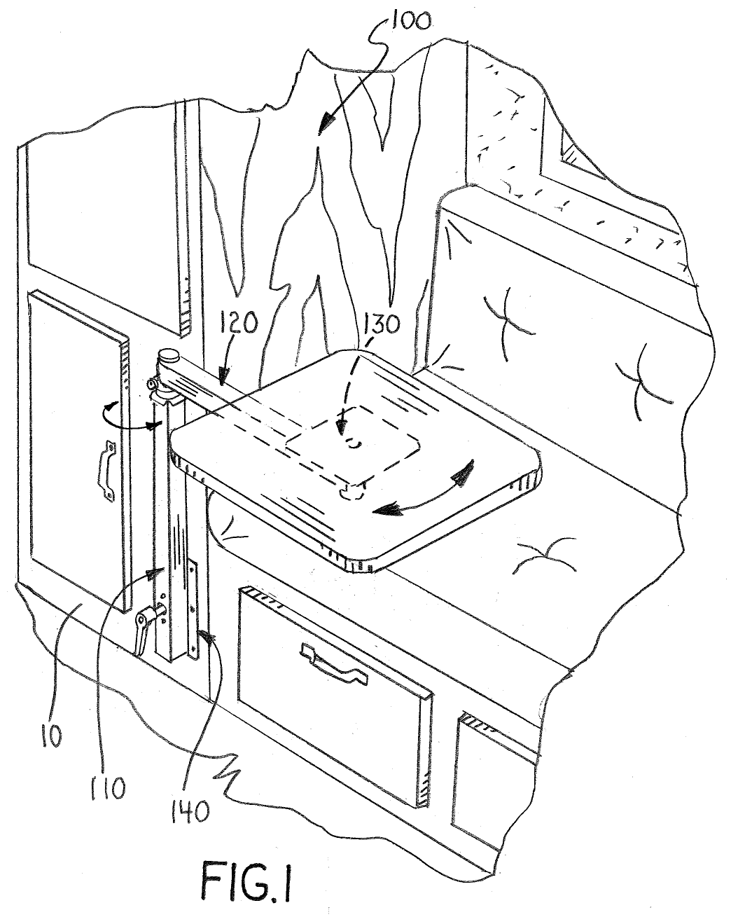

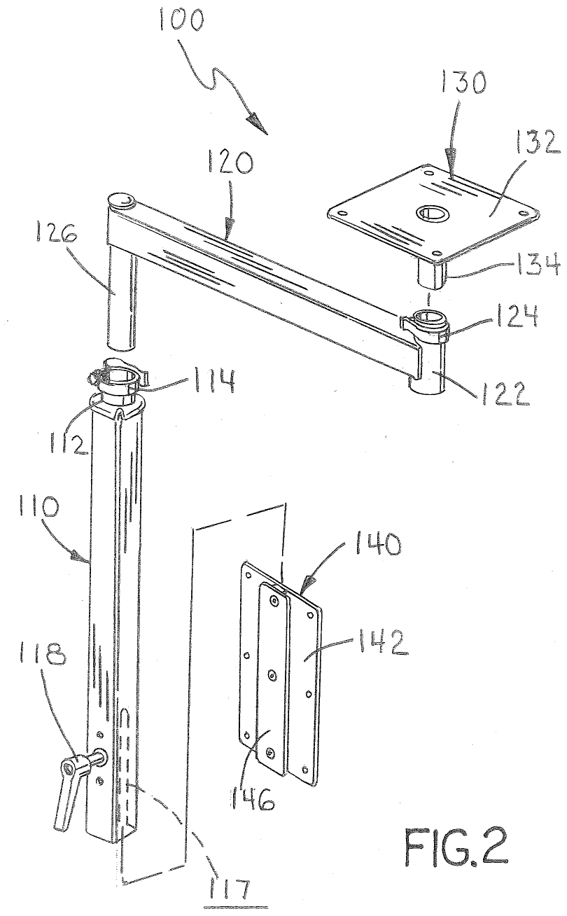

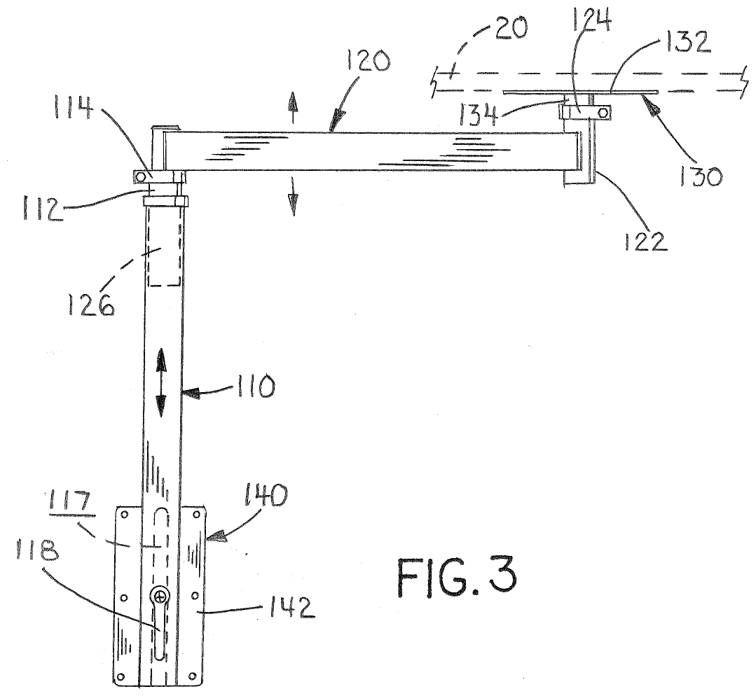

Referring now to the drawings, FIGS. 1-8 illustrate an exemplary embodiment of the swing-out table of this invention, which is designated generally as reference numeral 100. Table assembly 100 is designed for use in recreational vehicles and other applications where living space is limited. Table assembly 100 provides convenient tables or countertops, which can be raised, rotated and moved i.e., “swung” out of the way to allow ease of user movement around the living space and table. Table assembly 100 can be locked or secured in any particular position or orientation to hold the table in place and prevent inadvertent movement. In addition, table assembly 100 can be disassembled for convenient storage, and accommodates any shape and size of table top for use in any particular application or use. The various components of the table assembly are generally constructed from suitable metal tubing and plates to provide a secure and sturdy platform, but may be fashioned from other suitable materials in alternative embodiments.

As shown best in FIG. 1, table assembly 100 is a wall mounted embodiment. Table assembly 100 includes four main detachable components: a vertical post 110, a swing arm 120, table bracket 130, which supports a conventional table top 138, and a wall mount 140. Wall mount 140 detachably secures post 110 to a vertical surface or wall 10 within the living space. As shown, the table top 138 mounted to table bracket 130 is square but may be configured in any shape or size.

Post 110 is a length of square metal tubing. Post 100 includes a post head 112 welded to its top end for rotatably receiving swing arm 120. Post head 112 includes a collar clamp for locking swing arm 120 at the desired rotational position. Post 110 has a longitudinal slot 117 at its bottom end for receiving wall mount 140. Post 110 also includes a hand set screw 118 that extends laterally through the post to engage wall mount 140 and secure post 110 to the mount.

Swing arm 120 is a length of square metal tubing. Swing arm 120 includes a table receiver 122 welded to its free end for receiving table plate 130. Table receiver 122 includes a collar clamp for locking table plate 130 at the desired rotation position. Swing arm 120 also includes a post shaft 126, which is detachably and rotatably seated within post head 112. The length of post shaft 126 allows table top 138 to be selectively raised and lowered to any desired height.

Table bracket 130 includes a flat plate 132 and table shaft 134, which is detachably and rotatably seated within table receiver 122. Table top 138 is affixed to the top of plate 132 using conventional means, such as screw fasteners or adhesives.

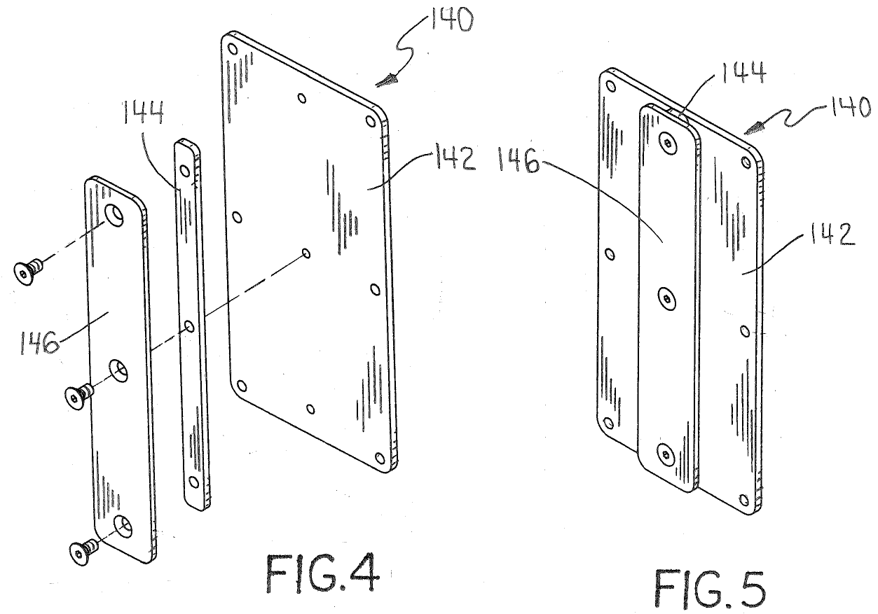

Wall bracket 140 is mounted to an interior wall or vertical surface within the living space. Wall mount 140 includes a back plate 142, a rail back 144 and a rail plate 146. Back plate 142 is affixed to the wall or vertical surface 10 within the living space using conventional screw fasteners (not shown). As best shown in FIGS. 4 and 5, rail back 144 and rail plate 146 are bolted to back plate 142 using screw fasteners to provide a rail track that seats within slot 117 of post 110. Hand set screw 118 is tightened to engage rail plate 146 and hold post 110 to wall mount 140.

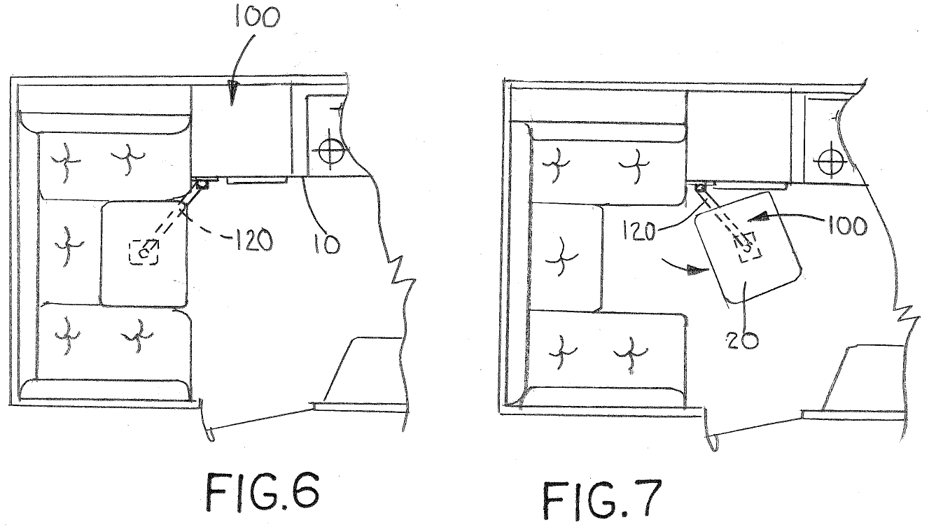

As shown in FIGS. 6 and 7, swing arm 120 and table bracket 130 allow table top 138 to pivot and rotate between various positions within the living space. Clamp collars 114 and 124 are tightened and released to allow or restrict movement and rotation of the swing arm 120 and table bracket 130, respectively. When not in use, the four main components of table assembly 100 can be disconnected for ease of storage. Multiple wall mounts 140 can be secured at various location within the living space so that table assembly 100 can be used at varying locations.

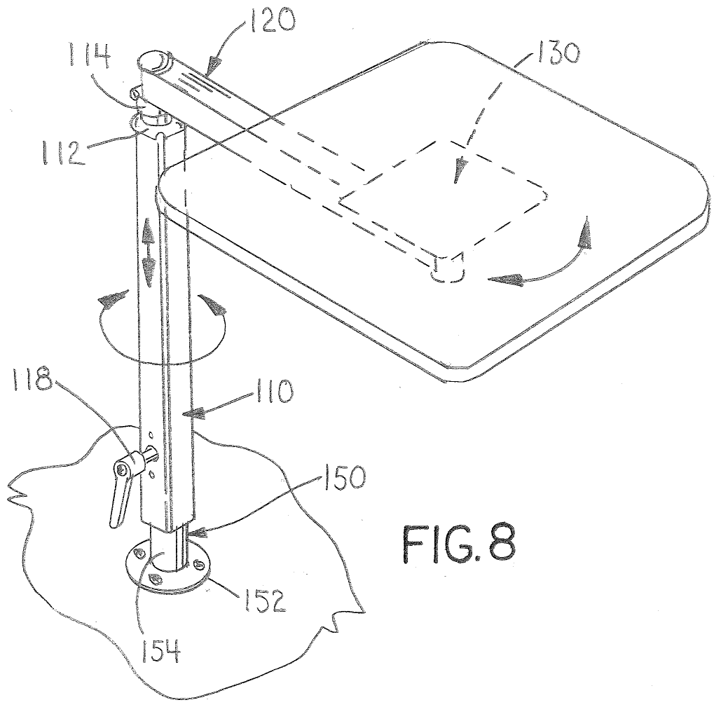

FIG. 8 illustrates table assembly 100 as a floor mount embodiment. As shown, the table assembly simply replaces wall mount 140 with a floor mount 150. Floor mount 150 includes a base plate 152 affixed to the floor of the living space and a vertical post 154. Post 110 seats atop post shaft 154 and is secured by hand set screw 118. Using floor mount 150, swing arm 120 is free to rotate a full 360 degrees about post 110 in most applications. Again, multiple floor mounts 150 can be secured at various locations within the living space so that table assembly 100 can be used at varying locations.

It should be apparent from the foregoing that an invention having significant advantages has been provided. While the invention is shown in only a few of its forms, it is not just limited but is susceptible to various changes and modifications without departing from the spirit thereof. The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. A table assembly for a living space defined by a wall and a floor, the table assembly comprising:
a mounting part fixed to the vehicle interior;
a post detachably mounted to the mounting part;
a swing arm detachably mounted to the post for rotational movement about the longitudinal axis of the post;
a table bracket detachably mounted to the swing arm for rotational movement perpendicular to the longitudinal axis of the swing arm.

2. The table assembly of claim 1 and a table top affixed to the table bracket.

3. The table assembly of claim 1 wherein the mounting part is affixed to the wall.

4. The table assembly of claim 1 wherein the mounting part is affixed to the floor.

5. The table assembly of claim 1 wherein the swing arm includes a post shaft affixed to one end thereof and a table receiver affixed to the other end thereof, the post shaft rotatably disposed within the post, the table bracket includes a plate and a table shaft, the table shaft rotatably disposed within the table receiver.

6. The table assembly of claim 5 wherein the post includes a post head for receiving the post shaft and a clamp for securing the orientation of the swing arm relative to the post.

7. The table assembly of claim 5 wherein the table receiver includes a clamp for securing the orientation of the table bracket relative to the swing arm.

8. The table assembly of claim 2 wherein the mounting part includes a back plate adapted to affix to the wall and rail part extending from the back plate.

9. The table assembly of claim 8 wherein the post has a longitudinal slot for receiving the rail part therein.

10. The table assembly of claim 3 wherein the mounting part includes a floor plate adapted to affix to the floor and mount shaft extending from the floor plate, the post adapted to seat atop the mount shaft.
